(19) United States
(12) Patent Application Publication
(10) Pub. No.: US 2010/0042529 A1
(43) Pub. Date: Feb. 18, 2010

(54) Fund Bidding Method

(76) Inventors: Yung-Sung Chien, Taipei City (TW); Hsiao-Ling Hsu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/581,867

(22) Filed: Oct. 19, 2009

Related U.S. Application Data
(63) Continuation-in-part of application No. 11/708,334, filed on Feb. 21, 2007, now abandoned.

(30) Foreign Application Priority Data
Jan. 31, 2007 (TW) 096103570

(51) Int. Cl. G06Q 40/00

(52) U.S. Cl. 705/37

(57) ABSTRACT

For relieving a bid winner from receiving an unexpected amount of total fund while there is no member of a mutual fund association issuing a qualified bid, which is higher than a basic bid, a fund bidding method tends to relieve the bid winner by providing an option for each member of the mutual fund association to issue an unqualified bid, which is lower than the basic bid. According to the fund bidding method, while there is no member issuing the qualified bid at a current term, a bid winner is determined to be a member issuing a lowest unqualified bid, is going to be paid with a compensable total fund at the current term.

### CROSS REFERENCE TO RELATED APPLICATIONS

This application is a continuation-in-part of U.S. application Ser. No. 11/708,334, filed on Feb. 21, 2007, the contents of which are incorporated herein by reference.

### BACKGROUND OF THE INVENTION

1. Field of the Invention

The present invention relates to financial electronic commence, and more particularly, to a fund bidding method applied for civil mutual aid associations and a system thereof.

2. Description of the Prior Art

A mutual fund association may enable direct loaning for members of the mutual fund association. Besides providing an un-traditional funding way except for conventional banks, the mutual fund association may also have the members deposit money, reach a higher return rate of investment, and suffer slighter burdens from taxes.

In rise of a mutual fund association, an association header looks for members tending to enter the mutual fund association, and regulates a fund for each the member, a number of terms of the mutual fund association, an initial date of the mutual fund association, using internal/external bids, and a basic bid. Since the date of the initial date and in each succeeding term of the mutual fund association, a bid winner issuing a highest bid is determined, and each of other non-bid members then pays a regulated fund to the bid winner according to whether an internal or external bid is used and according to whether the other non-bid members is a non-bid winner, who has won a bid in a previous term of the mutual fund association and gives up the right to issue another bid after he won his bid, or a pure non-bid member, who never wins in preceding terms of the mutual fund association.

If there are at least two members issuing a same amount of bids at a specific term, the bid winner is determined by drawing lots by the at least two members, i.e., in a random manner. However, if there is no member issuing a bid in a specific term, i.e., when no member of the mutual fund association urges for money at the specific term, a bid winner has to be determined in a random manner among remaining pure non-bid members of the mutual fund association. However, any member of the mutual fund association has to issue a bid higher than the above-mentioned basic bid, therefore, the randomly-determined bid winner has to be unwillingly rewarded with a total fund, which equals to a sum of paid funds of other non-bid members at the specific term and may be much lower than an expected fund of the bid winner. Besides, the unwilling bid winner may has to pay a higher interest at each of the succeeding terms of the mutual fund association, where the higher interest corresponds to a lower issued bid of a bid winner. As a result, being rewarded with an unexpected amount of total fund may actually make the unwilling bid-winner suffer a forced loss.

### SUMMARY OF THE INVENTION

The claimed invention tends to relieve the non-bid winner from receiving an unexpected amount of total fund, and thereby raises attraction of the mutual fund association as a result since fairness and effectiveness of the mutual fund association at its each term are ensured in the claimed invention.

The claimed invention discloses a fund bidding method implemented on a bid processing system. The fund bidding method comprises the bid processing system establishing a mutual fund association; and the bid processing system determines initiating a bidding for unqualifiedly-issued bids while there is no member of the mutual fund association issuing a first bidding condition and while there is at least one member of the mutual fund association issuing a second bidding condition. The first bidding condition indicates a qualified bid higher than a basic bid regulated by the mutual fund association. The second bidding condition indicates an unqualified bid lower then the basic bid.

The claimed invention discloses a fund bidding method implemented on a bid processing system. The fund bidding method comprises establishing a mutual fund association by a bid processing system; the bid processing system initiating a winning bid at a first term of the mutual fund association according to issued bids of members of the mutual fund association when there is no bid leader in the mutual fund association; the bid processing system determining a winning bid at succeeding terms of the first term according to qualifiedly-issued bids, which are higher than a basic bid regulated by the mutual fund association, of the members of the mutual fund association; and performing exchange and transfer within the mutual fund association, wherein any transfer or exchange related to anyone outside the mutual fund association is prohibited. The bid processing system cooperates with a credit reference agency to investigate credit line of the members of the mutual fund association or perform settlement of accounts of the members of the mutual fund association so that the credit reference agency is capable of ensuring credits of members of the mutual fund association.

The claimed invention discloses a fund bidding method implemented on a bid processing system. The method comprises the bid processing system establishing a mutual fund association; the bid processing system initiating a bidding for unqualifiedly-issued bids while there is no member of the mutual fund association issuing a first bidding condition and while there is at least one member of the mutual fund association issuing a second bidding condition; the bid processing system determining a winning bid at a first term of the mutual fund association according to issued bids of members of the mutual fund association when there is no bid leader in the mutual fund association; and performing exchange and transfer within the mutual fund association. Any transfer or exchange related to anyone outside the mutual fund association is prohibited. The first bidding condition indicates a qualified bid higher than a basic bid regulated by the mutual fund association. The second bidding condition indicates an unqualified bid lower than the basic bid. The bid processing system cooperates with a credit reference agency to investigate credit line of the members of the mutual fund association or perform settlement of accounts of the members of the mutual fund association so that the credit reference agency is capable of ensuring credits of members of the mutual fund association.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings, which are incorporated in and constitute a part of this specification, illustrate a system consistent with the principles of the invention and, together with the description, serve to explain the principles of the invention.

FIG. 1 is a flow-chart of a method of auctioning money consistent with the present invention.

FIG. 2 is a flow-chart of a membership application and verification method consistent with the present invention.

FIG. 3 is a flow-chart of a login method consistent with the present invention.

FIG. 4 is a flow-chart of a transaction pool generation method consistent with the present invention.

FIG. 5 is a flow-chart of an auctioneering method consistent with the present invention.

FIG. 6 is a flow-chart of a settlement and liquidation method consistent with the present invention.

FIG. 7 is a flow-chart of an auction certificate mortgage method consistent with the present invention.

FIG. 8 is a flow-chart of an auction certificate bidding method consistent with the present invention.

FIG. 9 is a flow-chart of an auction certificate negotiation method consistent with the present invention.

FIG. 10 is a block diagram of a money auctioneering platform consistent with the present invention.

FIG. 11 illustrates the fund bidding method according to a preferred embodiment of the present invention.

FIG. 12 illustrates the above-mentioned bid processing system according to a preferred embodiment of the present invention.

### DETAILED DESCRIPTION

An auctioneering platform for auctioning money is disclosed. The auctioneering platform may provide a system for constructing a pool of money in an auction pool. A plurality of participants participate in the auction pool, with participants contributing money into the auction pool over a period of terms, where the number of terms may be equal to the number of participants. Participants may bid on the money in the pool during each term, with the highest bid receiving the money in the pool. The non bid winning participants each contribute into the pool, receiving an auction certificate.

Auction certificates may be either physical or electronic documents or records. The use of auction certificates facilitates the creation of a secondary market, where auction certificates may be, for example, transferred, negotiated, or auctioned in either physical, electronic, or virtual environments.

Bid winners contribute into the pool for each subsequent term. For each term of the pool, the bidding process is repeated, until each participant of the pool wins a bid. At that point, the pool is complete. Thus, participants may choose to be a lender or a borrower based on, for example, the participant's need for money and the auction.

Auction certificates may be settled when the non bid winners win the bid. Auction certificates are equity instruments that may be, for example, transferred, mortgaged, or auctioned. Thus, the present auctioneering platform enhances the liquidity of capital put into the auction pool.

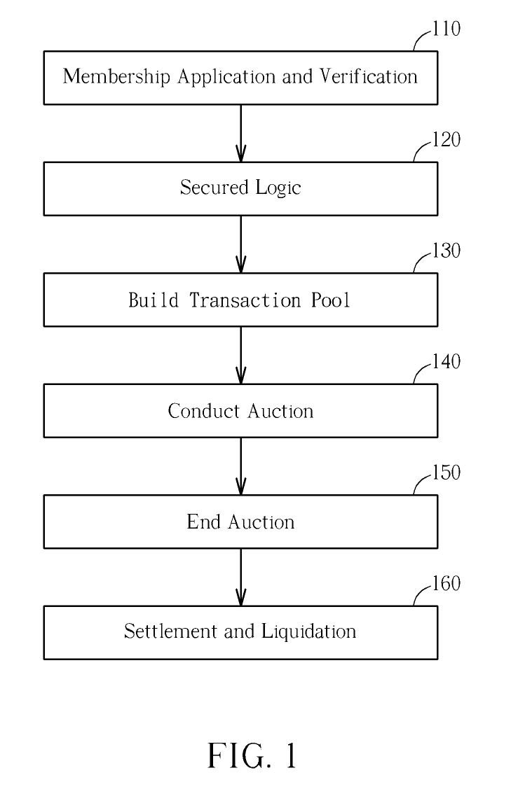

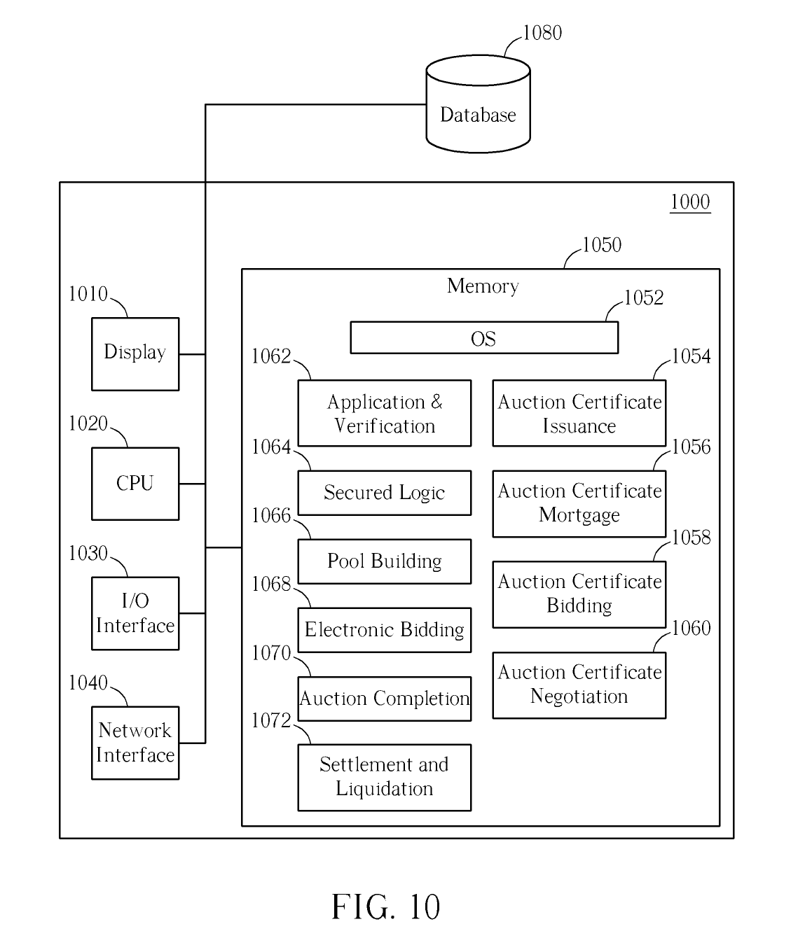

FIG. 1 is a flow-chart of a method of auctioning money consistent with the present invention. Auctioneering platform 1000 (illustrated in FIG. 10) may accept membership applications, verify application data, determine qualification for membership, and grant or deny membership to applicants (stage 110). Platform 1000 may provide for the secure login of members by receiving a member number and password and verifying that the password matches the member number If so, login will be granted (stage 120).

After login, platform 1000 may build a transaction pool comprising a plurality of members. Members who belong to a transaction pool are known as participants (stage 130). The transaction pool may be for a fixed number of terms equal to the number of participants in the pool. Thus, each participant may win the pool during a single term. The transaction pool may also specify the contribution unit for each term. Once a transaction pool is generated, platform 1000 may conduct an auction of each term in the transaction pool (stage 140). Bids are received from each participant, with the highest bid winning the pool. Platform 1000 may end the auction (stage 150) and settle and liquidate the auction pool (stage 160) with the highest bidder getting the money in the auction pool for the term that he won and the non bid winners of each term receiving auction certificates.

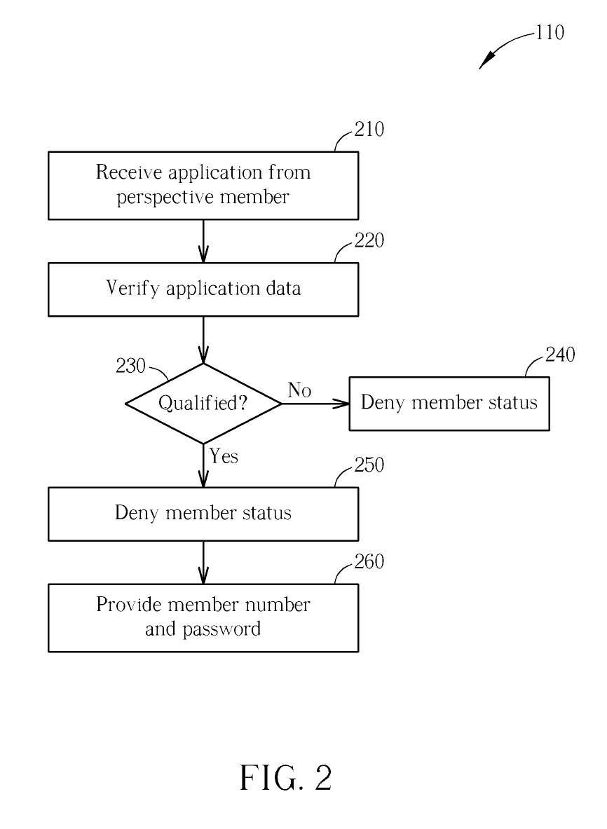

FIG. 2 is a flow-chart of the membership application and verification method 110 consistent with the present invention. Platform 1000 receives an application for membership from an applicant (stage 210). Application data is verified (stage 220), and the applicant's qualification are checked (stage 230). If the applicant is not qualified, the applicant may be denied membership (stage 240). If the applicant is qualified, he may be granted member status (stage 250). Platform 1000 provides members with membership data, for example a member number and a password (stage 260).

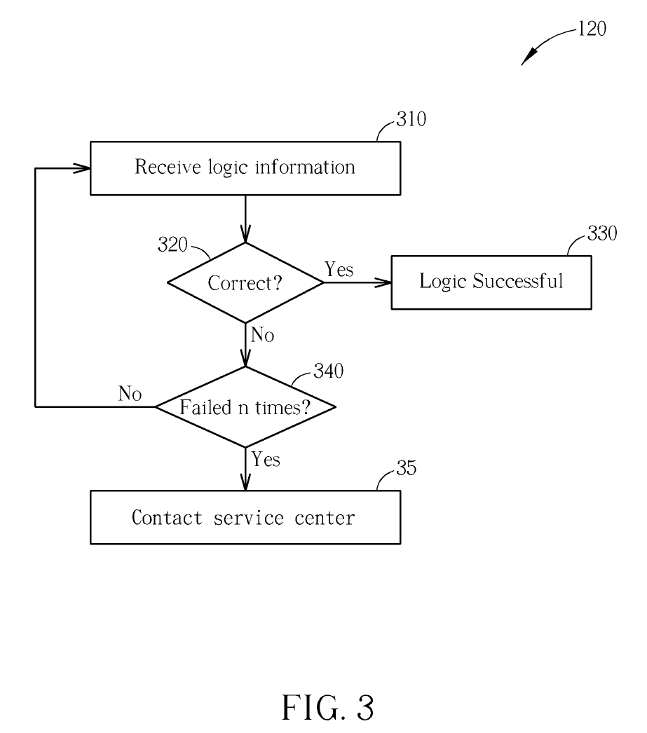

FIG. 3 is a flow-chart of the login method 120 consistent with the present invention. Platform 1000 receives login information from a member, for example a member number and password (stage 310). The login information may be checked against an auction database that maintains membership data (stage 320). If the login information matches the membership data, the login is successful and the member is granted access to auctioneering platform 1000 (stage 330). If the login information is incorrect, a check is made as to how many times the login information containing the member number has failed the login check of stage 320 (stage 340). If the login fails for greater than a set number of times following the last successful login, for example 3 times, a notification is sent to the member corresponding to the member number to contact the service center (stage 350). If the login fails for a number of times less than the set number of times, the method returns to stage 310 and the user is given another opportunity to login.

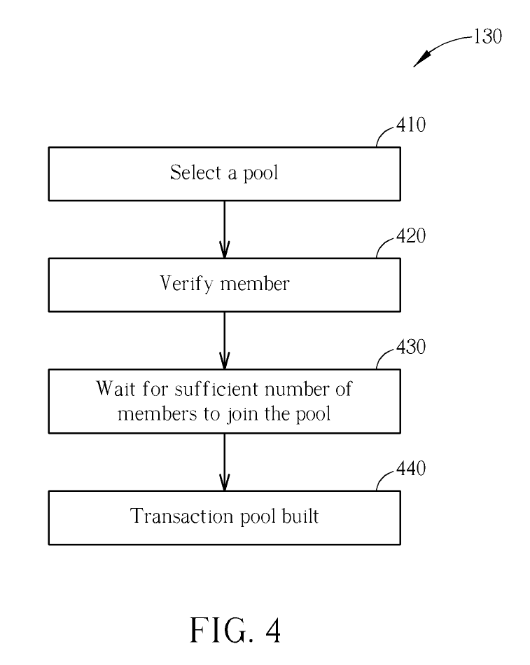

FIG. 4 is a flow-chart of the transaction pool generation method 130 consistent with the present invention. A member selects a transaction pool (stage 410). The transaction pool will be for a number of terms, for example 12 months, 24 months, or 36 months. The transaction pool may also specify a unit contribution amount for each term, for example $10,000 per participant. Platform 1000 may verify that the member is qualified for the transaction pool selected (stage 420). Platform 1000 waits to build the pool until the number of members joining the transaction pool is equal to the number of terms in the pool (stage 430). Once the number of members in the pool equal the number of terms in the pool, the transaction pool may be built and members become participants in the pool (stage 440).

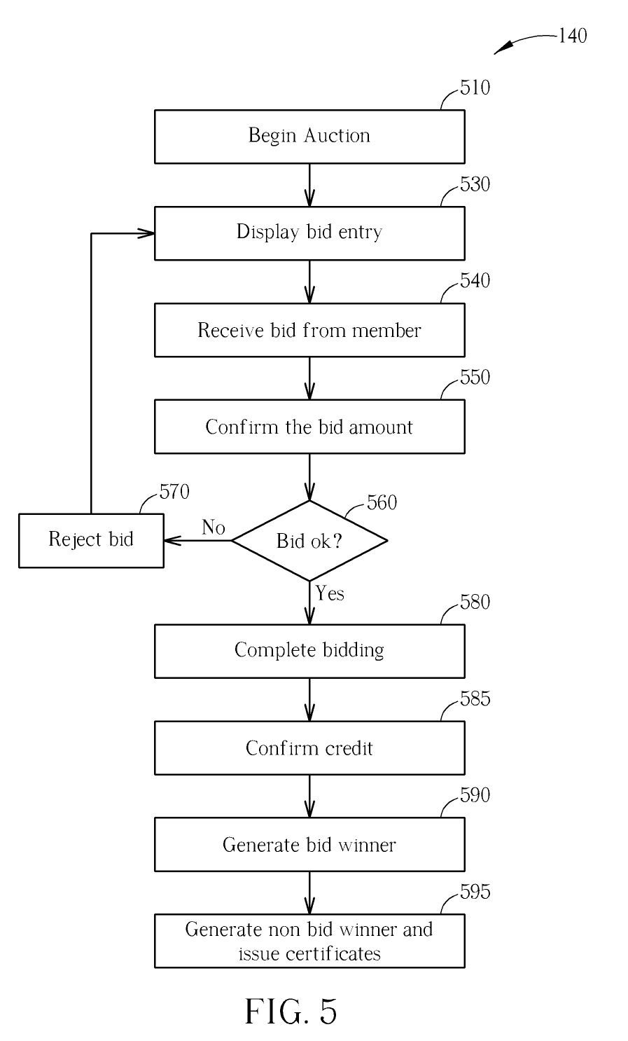

FIG. 5 is a flow-chart of the auctioneering method 140 consistent with the present invention. Consistent with the present invention, bidding may be performed on a term by term basis, around the time of each term. For example, if the auction is for a 24 term auction with 24 participants, and each term is one month, auctioneering method 140 may occur on a monthly basis for the auction certificate for that month or the upcoming month. Thus, each term auctioneering method 140 may be performed for each auction pool. Unlike a traditional ROSCA which does not permit bidding on the first term (generally the ROSCA organizer “wins” the first term), consistent with the present invention auctioneering platform 1000 may permit bidding by the participants on the first term.

Platform 1000 begins the auction of a transaction pool after the transaction pool is built (stage 510). Participants then enter the auction for the transaction pool. Participants may be presented with a form or table into which bids are displayed and they may enter their bids for each term (stages 530 and 540). Platform 1000 receives bids from the participants (stage 540) and confirms the bid amount with the bidding participant (stage 550). Platform 1000 examines the bid (stage 560). If the bid is greater than a set upper alert amount, the bid may be rejected, and if the bid is over a time limit, the bid may also be rejected (stage 570). Additionally, the bid may be checked against a set lower alert amount and may be rejected if the bid is below the set lower alert amount. (stage 570). The participant may be given an opportunity to reenter the bid if the bid is greater than the set alert amount but not above the time limit at stage 530. If the bid is valid, the bidding process completes (stage 580).

At the completion of the bidding process, one or more participants may be candidate winners. A candidate winner may be selected, for example, based on the participant, or participants, who had the highest bid. A credit check may be conducted on the candidate winners, and if the bid (the amount that the candidate winner would receive by winning the auction) is greater than the amount of credit available to the candidate winner then the bid from the candidate winner may be rejected and other candidate winners selected (stage 585). The credit check may determine if the credit available to the candidate winner is greater than the amount that the candidate winner would receive by winning the auction. The amount received may be calculated as shown in the paragraph below. Following approval of credit, platform 1000 selects one or more candidate winners as one or more bid winners. (stage 590). Non-bid winners are notified and each provided with an auction certificate (stage 595).

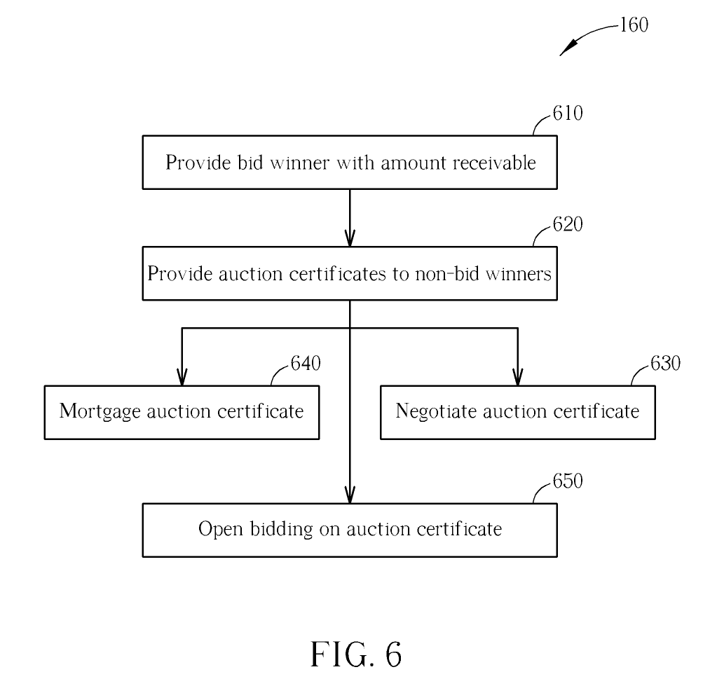

FIG. 6 is a flow-chart of the settlement and liquidation method consistent with the present invention. Platform 1000 receives payment from the non bid winners into a settlement account and remits the amount in the settlement account to the bid winner (stage 610). The amount received by the bid winner may be determined by the following formula: An=(U−In)(N−i)+U(i−1), where An is the payment amount to the bid winner of the selected term; U is the contribution amount; N is the number of terms; i is the number of the selected term; and In is the amount of the bid from the bid winner.

For example, in a pool of 24 terms with a deposit of $10,000 per term, there will be 24 participants. If participant A bids $1,000 and wins term 6, participant A would receive An=(10,000−1,000).times.(24−6)+10,000(6−1)=$212,000. By term 6, the non-bid winners in the pool would pay $9,000 and the past bid winners of the pool would pay $10,000.

Platform 1000 provides an auction certificate to each of the non-bid winners (stage 620). After reading this specification, those skilled in the art will appreciate that there are multiple ways to handle settlement. For example, the bid winner could receive payment prior to collection from the non-bid winners. Or, the non-bid winners could initially contribute prior to paying the bid winner. Or, the collection and remittance could occur essentially simultaneously. For non bid winners who fail to make payment, platform 1000 could press the delinquent non bid winners. For example, the right to participate in other pools could be withheld.

To enhance liquidity, the fixed duration and participants may be enhanced by using the auction certificates as equity instruments. Thus, the auction certificates can be mortgaged (stage 640), auctioned (stage 650), or negotiated (stage 630).

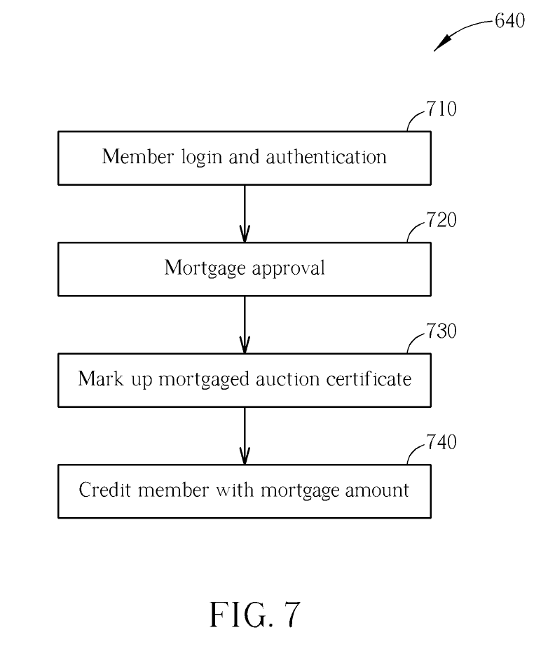

FIG. 7 is a flow-chart of the auction certificate mortgage method 640 consistent with the present invention. Platform 1000 accepts a member login and authenticates the member (stage 710). The platform may approve the mortgage of the auction certificate (stage 720) and mark up the auction certificate for mortgage (stage 730). Following mark up, platform 1000 may credit the mortgaging member of the auction certificate with the mortgage amount. Thus, physical, electronic, or virtual mortgaging enhances the liquidity of the auction certificate.

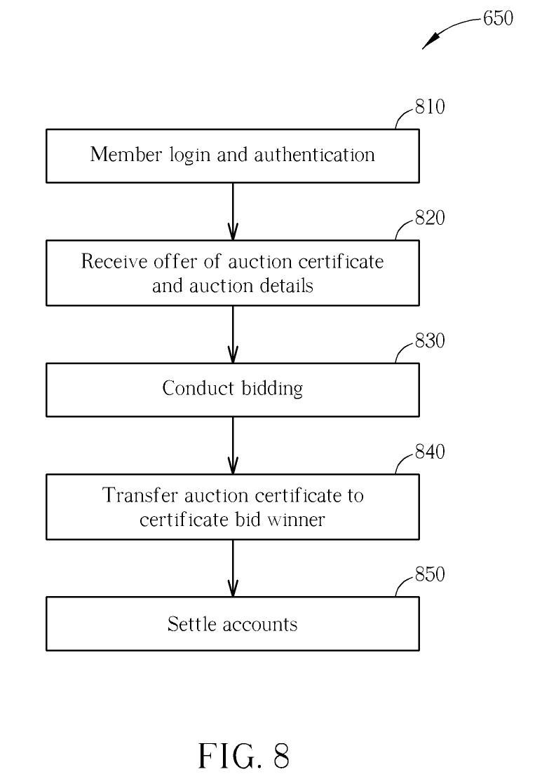

FIG. 8 is a flow-chart of the auction certificate bidding method 650 consistent with the present invention. Platform 1000 receives login information from a member and authenticates the member (stage 810). Auction certificate and details are received (stage 820). For example, the member may specify an opening bid and a time duration for the auction. Similarly, the member may place a reserve price on the auction certificate. Those skilled in the art will now appreciate the variety of auction techniques that may be applied to the auction certificate. Members may bid on the auction certificate (stage 830), with the auction certificate winner receiving the auction certificate (stage 840) and the winner remitting the price of the auction certificate into a settlement account for transfer to the original auction certificate holder (stage 850).

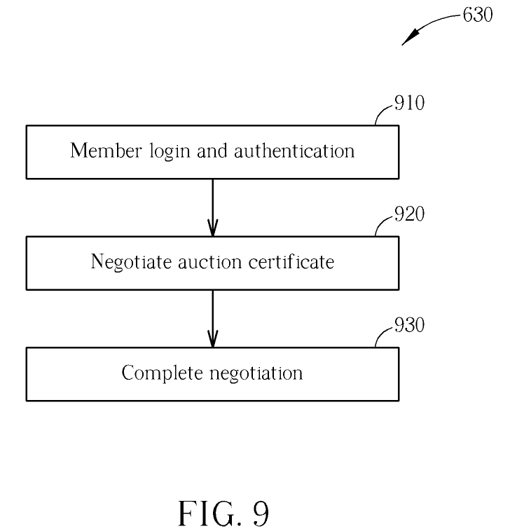

FIG. 9 is a flow-chart of the auction certificate negotiation method 630 consistent with the present invention. For conveyance of an auction certificate between members, platform 1000 receives login information from the parties to the transaction and verifies the login information (stage 910). The auction certificate is conveyed by platform 1000 at the price negotiated by the parties (stage 920) and the conveyance is completed by platform 1000 (stage 930).

FIG. 10 is a block diagram of the money auctioneering platform 1000 consistent with the present invention. As illustrated in FIG. 4, a system environment of auctioneering platform 1000 may include a display 1010, a central processing unit 1020, an input/output interface 1030, a network interface 1040, and memory 1050 coupled together by a bus. Auctioneering platform 1000 may be adapted to include the functionality and computing capabilities to auction money to a plurality of users over a network.

As shown in FIG. 10, auctioneering platform 1000 may comprise a PC or mainframe computer for performing various functions and operations consistent with the invention. Auctioneering platform 1000 may be implemented, for example, by a general purpose computer selectively activated or reconfigured by a computer program stored in the computer, or may be a specially constructed computing platform for carrying-out the features and operations of the present invention. Auctioneering platform 1000 may also be implemented or provided with a wide variety of components or subsystems including, for example, at least one of the following: at least one central processing units 1020, a co-processor, memory 1050, registers, and other data processing devices and subsystems.

Auctioneering platform 1000 may also communicate or transfer bids, auction data, auction results, and auction certificates via I/O interface 1030 and/or network interface 1040 through the use of direct connections or communication links to other elements of the present invention or to auction members at their respective remote communications platforms. For example, a firewall in network interface 1040, prevents access to the platform by unauthorized outside sources.

Alternatively, communication within auctioneering platform 1000 may be achieved through the use of a network architecture (not shown). In an alternative embodiment (not shown), the network architecture may comprise, alone or in any suitable combination, a telephone-based network (such as a PBX or POTS), a local area network (LAN), a wide area network (WAN), a dedicated intranet, and/or the Internet. Further, it may comprise any suitable combination of wired and/or wireless components and systems. By using dedicated communication links or shared network architecture, auctioneering platform 1000 may be located in the same location or at a geographically distant location from auction database 1080.

I/O interface 1030 of the system environment shown in FIG. 10 may be implemented with a wide variety of devices to receive and/or provide the data to and from auctioneering platform 1000. I/O interface 1030 may include an input device, a storage device, and/or a network. The input device may include a keyboard, a microphone, a mouse, a disk drive, video camera, magnetic card reader, or any other suitable input device for providing data to auctioneering platform 1000.

Network interface 1040 may be connected to a network, such as a Wide Area Network, a Local Area Network, or the Internet for providing read/write access to data in auction database 1080. Furthermore, network interface 1040 may serve as a web interface or gateway to one or more auction members operating a remote computing platform, such as a personal computer, web terminal, or mobile phone or personal digital assistant. Network interface 1040 may thus provide web access to auctioneering platform 1000.

Memory 1050 may be implemented with various forms of memory or storage devices, such as read-only memory (ROM) devices and random access memory (RAM) devices. Memory 1050 may also include a memory tape or disk drive for reading and providing records on a storage tape or disk as input to patent flow platform 1000. Memory 1050 may comprise computer instructions forming a plurality of modules. The modules may include an on-line auctioneering transaction module (not shown) comprising one or more of: an application and verification module 1062; a secured login module 1064; a pool building module 1066; an electronic bidding module 1068; an auction completion module 1070; and a settlement and liquidation module 1072.

Application and verification module 1062 may determine membership qualification based on verification information, and may also provide and maintain a member number and password for each respective member. Secured login module 1064 may accept member numbers and passwords, verify that the member number and password is valid, and permit entry into auctioneering platform 1000 based on the results of the verification. In addition, secured login module 1064 may bar access to auctioneering platform 1000 for members who enter an incorrect password a preset number of times, for example 3 times. After the barring, secured login module 1064 may notify the member to contact a system administrator.

Pool building module 1066 may build transaction pools with various terms, for example, 12, 24, and 36 terms, for qualified members Once a sufficient number of members join the pool, the pool may be built. Electronic bidding module 1068 controls bidding on built transaction pools. Electronic bidding module 1068 may display a bidding entry form, such as a bidding column, for each member to enter a bid into the entry form. Electronic bidding module 1068 may verify that the bid is below a maximum amount and, if so, accept the bid.

Auction completion module 1070 may examine, judge, and compare the amount of each bid at the end of bidding. Auction completion module 1070 may determine the maximum effective amount from among the bids as the winning bid. Settlement and liquidation module 1072 may collect the amount payable from the accounts, either virtual or physical, of the non bid winners. If payment is not collected before a deadline, settlement and liquidation module 1072 may make advances for the amounts due and press the non bid winners who failed to pay for collection. Settlement and liquidation module may collect the payments into a settlement account and disburse the settlement account to the bid winner.

Memory 1050 may also comprise an auction certificate transaction module (not shown) comprising one or more of: an auction certificate issuance module 1054; an auction certificate mortgage module 1056; and auction certificate bidding module 1058; and an auction certificate negotiation module 1060. Auction certificate issuance module 1054 may convert the amount receivable from non bid winners to one or more auction certificates. Auction certificate mortgage module 1056 may provide auction certificate mortgage functions and report mortgage results. Auction certificate bidding module 1058 may auction certificates to other members. Auction certificate bidding module 1058 may receive a minimum bid and duration from the auction certificate holder, display bids, determine the winner, and track the results of the auction. Further, auction certificate bidding module 1058 may transfer the payment for the auction certificate and the auction certificate between the winner and the auctioning member. Auction certificate negotiation module 1060 may assist member negotiation of auction certificates.

Auction database 1080 is coupled to auctioneering platform 1000. Auction database 1080 may include member registration data, member verification data, transaction pool data, electronic bids and results data, member virtual account data, and other data relevant to the functioning of the auctioneering platform 1000. Auction database 1080 may be electronic memory, magnetic memory, optical memory, or a combination thereof, for example, SDRAM, DDRAM, RAMBUS RAM, ROM, Flash memory, hard drives, floppy drives, optical storage drives, or tape drives. Auction database 1080 may comprise a single device, multiple devices, or multiple devices of multiple device types, for example, a combination of ROM and a hard drive.

Those skilled in the art will appreciate that all or part of systems and methods consistent with the present invention may be stored on or read from other computer-readable media, such as: secondary storage devices, like hard disks, floppy disks, flash storages, CD, or DVD; a carrier wave received from the Internet; or other forms of computer-readable memory, such as read-only memory (ROM), random-access memory (RAM), or magnetic RAM.

The present invention also discloses a fund bidding method for solving the defects of conventional mutual fund associations, and moreover, a system for implementing the fund bidding method of the present invention is also disclosed herein.

In a mutual fund association running the fund bidding method of the present invention, a member issuing a highest bid is a bid winner and takes a total fund in each term of the mutual fund association. Each member of the mutual fund association cannot issue another bid after he wins a bid, and is qualified to issue a bid at each term of the mutual fund association before he wins the bid. In a first term of the mutual fund association in the present invention, there may or may not be a bid leader. While there is no bid leader in the mutual fund association, a risk of breaking contracts and initiations of the mutual fund association is burdened by a system, which acts as the mutual fund association running the fund bidding method of the present invention. On the contrary, when there is a bid leader, the bid leader is naturally the bid winner of the first term of the mutual fund association. At the last term of the mutual fund association, there should be one last member, who is never a bid winner in the preceding terms, so that the last member is naturally the bid winner of the last term.

Payments between members of the mutual fund association form a zero-sum payment within the mutual fund association since no additional payment is made to anyone beyond the mutual fund association. A bid winner is authorized to retrieve funds from other members including non-bid winners and pure non-bid members at a current term, whereas the non-bid winners and the pure non-bid members are obligated in paying the funds to the bid winner at the current term. A pure non-bid member may affect his paid fund at each succeeding term by estimating his succeeding issued bids until he wins the bid at a succeeding term. A non-bid winner has to pay back the total fund, which he wins before, by installments at each succeeding term after he wins his bid.

The total fund of a bid winner or paid funds of the non-bid winners or the pure non-bid members at each term of the mutual fund association may be calculated according to whether the mutual fund association uses internal bids or external bids. Note again that a pure non-bid member indicates a member who never wins a bid at preceding terms, and that a non-bid winner indicates a member who has won his bid at a preceding term. The total fund paid to the bid winner at each term of the mutual fund association is a sum of paid funds of the non-bid winners and the pure non-bid members, or a fee equals to the sum subtracted by a service charge.

The issued bid of a member of the mutual fund association is regarded as a first bidding condition. While the mutual fund association uses internal bids, each pure non-bid member actually pays a fund equal to a basic fund subtracted by an issued bid of a current bid winner, and each non-bid winner actually pays a fund equal to the basic fund. While the mutual fund association uses external bids, each pure non-bid member actually pays a fund equal to the basic fund, and each non-bid winner actually pays a fund equal to the basic fund plus an issued bid, which is issued by the non-bid winner while the non-bid winner wins the bid in a preceding term.

In the present invention, while there is at least one member issuing a bid at a certain term of the mutual fund association, i.e., when it is not necessary to draw lots to randomly determine a bid winner, the total fund paid to a bid winner and the funds paid by the non-bid winners or the pure non-bid elements at the current term may be calculated as follows:

(1) Total fund paid to the current bid winner:

(a) Under the internal bids:

Aₙ=(U−Iₙ)×(N−n)+U×(n−1) (1);

(b) Under the external bids:

$${A}_{n} = U \times ( N - n ) + U \times ( n - 1 ) + {\sum }_{i = j}^{n - j} {I}_{i} ; \qquad ( 2 )$$

(2) Fund paid by each the pure non-bid member:

(a) Under the internal bids:

U−Iₙ (3);

(b) Under the external bids:

U (4);

(3) Fund paid by each the non-bid winner:

(a) Under the internal bids:

U (5);

(b) Under the external bids:

U+Iₙ (6)

Aₙ indicates the total fund of the bid winner at an n-th term, i.e., the current term, of the mutual fund association. U indicates the basic fund, which is also an upper bound of an issued bid for each member of the mutual fund association. N indicates a total number of terms of the mutual fund association. n indicates the current term of the mutual fund association, where n is less than N·Iₙ indicates an issued bid of the bid winner at the n-th term. Iᵢ indicates an issued bid of a bid winner at the i-th term, where is less than n.

Note that the above-mentioned service charge is not taken into considerations among the above-listed equations.

Also note that when there is a bid leader initiating a mutual fund association, a winning bid at the first term is directly set to 0, and when there is no bid leader, a winning bid at the first term is determined by issued first or second bidding conditions of members of the mutual fund association.

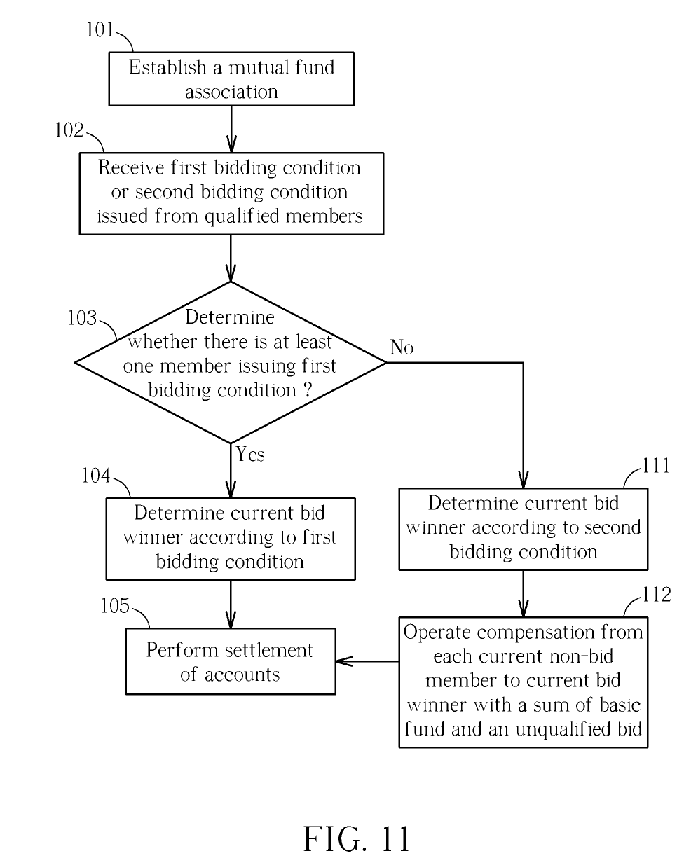

Please refer to FIG. 11, which illustrates the fund bidding method according to a preferred embodiment of the present invention. In Step 101 of FIG. 11, a mutual fund association is established on a bid processing system. The mutual fund association includes N members and N terms. The mutual fund association may be established according to various bidding conditions, which are given or issued by processing apparatuses of the members. In Step 102, at each term of the mutual fund association, the bid processing system instructs a qualified member to input the first bidding condition mentioned above or a second bidding condition.

Note that the qualified member is just a pure non-bid member, and the qualified member has a credit line or a credit quota higher than a total capital of the mutual fund association. The total capital of the mutual fund association is defined as a product of the basic fund and the number of total terms minus one, i.e., U×(N−1). The credit line of a member within the bid processing system is investigated and ensured by a credit reference agency, which or who is requested by the bid processing system. The credit quota is defined as a sum of the credit line and a system given quota, which is defined as a creditor right quota of the member minus a debt of the qualified member within the bid processing system. Note that the qualified member may also attend other mutual fund associations within the bid processing system so that both the creditor right quota and the debt quota of the member have to be calculated according to all the mutual fund associations that the member has attended.

Note that the creditor right quota of the member is defined as a total quota of all non-bid mutual fund associations attended by the member within the bid processing system. The creditor right quota may be calculated as:

Creditor right quota=(A total number of preceding terms of all the non-bid mutual fund associations attended by the member within the bid processing system)×(a basic fund regulated by the bid processing system) (7).

Note that the debt quota of the member is defined as a total unpaid amount of money of all bidden mutual fund associations attended by the member within the bid processing system. The debt quota may be calculated as:

Debt quota=(A total number of succeeding terms of all the bidden mutual fund associations attended by the member within the bid processing system)×(a basic fund regulated by the bid processing system) (8).

Note that the above-mentioned first bidding condition is used for determining a bid winner of a current term while at least one member of the mutual fund association issues a bid, and that the above-mentioned second bidding condition is used for determining a bid winner of a current term while no member of the mutual find association gives the first bidding condition, i.e., when no member of the mutual fund association urges for money at the current term, and as a result, a bid winner determined according to the second bidding condition is determined in a random manner by the bid processing system. Both the first and second bidding conditions are transferrable and enumerable gains, such as an amount of money or virtual coins, where the virtual coins are merely available within the bid processing system. For example, the first bidding condition may be an amount of money indicated by the bid issued by a member of the mutual fund association, where the amount of money of the issued bid under the first bidding condition is higher than the basic bid mentioned before. Similarly, the second bidding condition may be an unqualified bid, which has a lower amount of money than the basic bid has. Nota that a bid of a member is set to be a default bid by the bid processing system while the member does not issue the first bidding condition or the second bidding condition.

The first bidding condition is related to an interest of an available fund, where the interest is to be paid to the member who issues the first bidding condition. The second bidding condition provides a fair and direct mechanism in replacement of the conventional random way in determining the bid winner, i.e., drawing lots. If a member is not willing to win a bid at a current term, he may issue the unqualified bid according to the second bidding condition so that he could lower his probability in winning the bid at the current term. Moreover, the second bidding condition given by the member may also partially compensate loss in interest since a member giving a lowest unqualified bid is determined to be the bid winner, who may be unwilling to win the bid. As a result, fairness and stableness of the bidding system may thus be maintained.

After the bid processing system receives a first bidding condition or a second bidding condition given by each member of the mutual fund association at a current term in Step 102, in Step 103, the bid processing system determines whether there is at least one member issuing the first bidding condition. In Step 104, when there is at least one member issuing the first bidding condition, the bid processing system determines a bid winner at the current term directly from one of the at least one member issuing the first bidding condition. For example, suppose that each member issues a first bidding condition, which indicates an issued bid I, at a term n, then the bid processing system may determine a member who issues a highest bid Iₙ among all the members, who have issued the bid I, as the bid winner at the term n. In Step 111, when there is no member issuing the first bidding condition, the bid processing system determines a bid winner according to all issued second bidding conditions, where all the issued second bidding conditions indicating bids lower than the basic bid so that all the issued second bidding conditions are unqualified bids. For example, suppose that each of the members of the mutual fund association gives an unqualified bid J, when a member issues a second bidding condition indicating a lowest unqualified bid J among all the unqualified bids, or when the member does not give the second bidding condition, the member is determined as the bid winner at the current term by the bid processing system. At this time, in Step 112, the bid winner determined according to the second bidding condition is compensated from each of the other non-bid members or non-bid winners with the unqualified bid J that they issue respectively, where the compensation is operated by the bidding system; note that the bid winner is still paid from each of the other pure non-bid members or non-bid winners with the basic fund at the current term.

After the bid winner is determined according to the second bidding condition, in Step 105, the bid processing system may perform a settlement of accounts accordingly. The settlement of accounts may include issuing a first message and a second message, where the first message is to have each of the non-bid members pay an actual fund, which indicates the basic fund plus the unqualified bid J issued by each of the non-bid members at the current term, and where the second message is to have the bid winner retrieve the total fund at the current term. Note that the total fund equals to a sum of the actual fund of each of the non-bid members or equal to the sum minus a system service fee of each of the non-bid members.

As mentioned before, the non-bid members include non-bid winners and pure non-bid members, where a non-bid winner wins a bid in a preceding term and is restricted from issuing a bid in the succeeding terms, and where a pure non-bid member never wins a bid in any preceding terms or in a current term. The first message is transmitted to each of the non-bid members at the current term and/or to a credit reference agency, which may be a bank or a finance company cooperating with the bid processing system, so that each of the non-bid members at the current term pays the actual fund respectively by following instructions of the first message. The second message is transmitted to the bid winner at the current term and/or the credit reference agency so that the credit reference agency may pays the bid winner to the bid winner by following instructions of the second message.

Calculations of the actual fund for each of the non-bid members and of the total fund paid to the bid winner may follow an internal bid or an external bid. While following the internal bid, each member of the mutual fund association has to pay an interest at each term before he wins the bid. While following the external bid, each member of the mutual fund association has to pay an interest at each term after he wins the bid.

Under the internal bid and at a current term of the mutual fund association, a non-bid winner pays the basic fund U, which is predetermined for each member of the mutual fund association at each term by the bid processing system. When there is at least one pure non-bid member issuing a bid I through the first bidding condition, an actual fund paid by the at least pure one non-bid member should be U−I. When there is no pure non-bid member issuing the first bidding condition, each the pure non-bid member pays U+J−L, where J indicates the bid issued by each pure non-bid member respectively, and L indicates the basic bid, which also indicates a lowest interest paid by each member at each term. The basic bid L may be predetermined by the bid processing system or be set to 0.

Under the external bid and at a current term of the mutual fund association, a non-bid winner pays the basic fund U plus a winning bid Iᵢ issued by the non-bid winner at an i-th term, which is earlier than the current term n. When there is at least one pure non-bid member issuing a bid I through the first bidding condition, an actual fund paid by the at least pure one non-bid member should be the basic fund U. When there is no pure non-bid member issuing the first bidding condition, each the pure non-bid member pays U+J.

The disclosed bid processing system, which implements the fund bidding system of the present invention, may be a computer program, which may be stored in computer-readable medium, such as a compact disc, a hard drive, or a memory card.

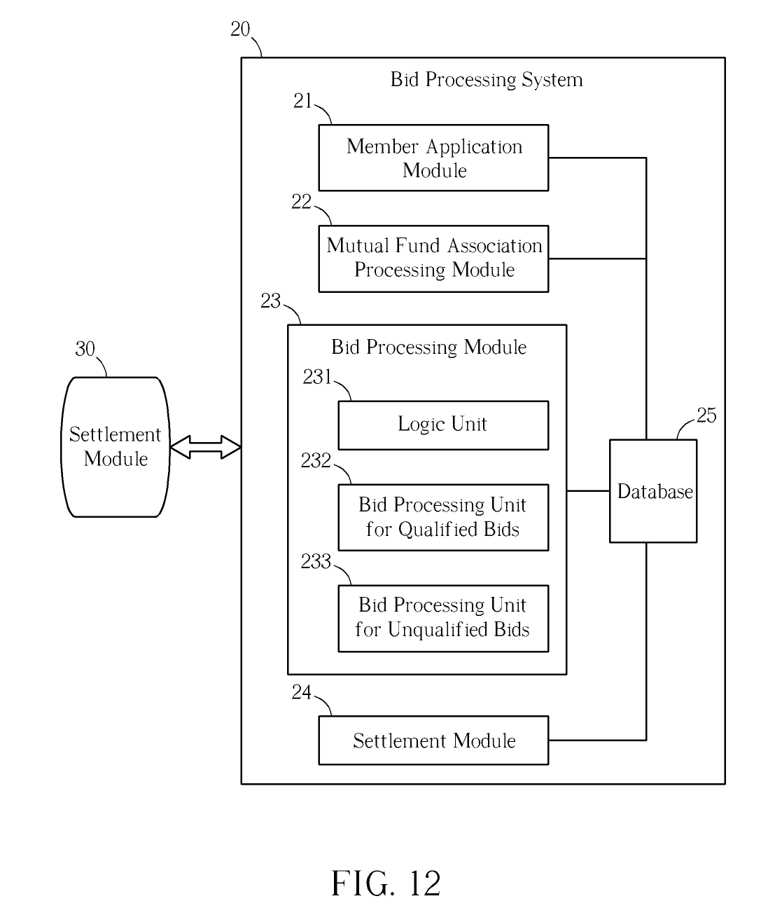

Please refer to FIG. 12, which illustrates the above-mentioned bid processing system according to a preferred embodiment of the present invention. In FIG. 12, a bid processing system 20 communicates with a client terminal 30, where a member of the mutual fund association is located, with a network, a physically-connected means of communication, or a wireless means of communication. Note that the client terminal 30 may be implemented with a computer, a cell phone, or a personal digital assistant. The member may communicate with the bid processing system 20 through the client terminal 30 in an instant and safe manner. The bid processing system 20 includes a member application module 21, a mutual fund association processing module 22, a bid processing module 23, and a settlement module 24. The member application module 21 is used for receiving requests of member applications, and for evaluating credits of members issuing applications. The mutual fund processing module 22 is used for grouping members having consistent conditions in applying membership of a mutual fund association, where the consistent conditions may include an expected number of total terms in a mutual fund association, a basic fund, or a total capital. An established mutual fund association may include at least two members. The bid processing module 23 is used for processing a bidding procedure and for determining a bidding result at each term of the mutual fund association, where the bidding result may include a current bid winner and other current non-bid members. The settlement module 24 is used for perform settlement of accounts according to the bidding result. The database 25 is used for storing personal information of each member issuing applications to the bid processing system 20, where the personal information may include basic information, attended mutual fund associations, issued bidding conditions, a credit status, or a credit quota, of each the member.

The bid processing module 23 is configured to receive a first bidding condition or a second bidding condition issued from a qualified member, and to determine a current bid winner according to either the first bidding condition or the second bidding condition. Note that both the first and second bidding conditions may refer to transferable and enumerable profits. For example, the first bidding condition may indicate an amount of money of an issued and qualified bid, and the second bidding condition may indicate an amount of money of an issued and unqualified bid. The bid processing module 23 includes a logic unit 231, a bid processing unit 232 for qualified bids, and a bid processing unit 233 for unqualified bids. The logic unit 231 is used for determining whether there is at least one member issuing the first bidding condition. When there is at least one member issuing the first bidding condition, the logic unit 231 orders the bid processing unit 232 to determine a current bid winner according to the first bidding condition. For example, the bid processing unit 232 may determine a member issuing a highest qualified bid under the first bidding condition as the current bid winner. Else, when there is no member issuing the first bidding condition, the logic unit 231 orders the bid processing unit 233 to determine a current bid winner according to the second bidding condition. For example, the bid processing unit 233 may determine a member issuing a lowest unqualified bid as the current bid winner.

After determining the current bid winner, the settlement module 24 issues the first message to both the credit reference agency and each current non-bid member so that each the current non-bid member pays an actual fund at the current term, and issues the second message to both the credit reference agency and the current bid winner so that the credit reference agency pays a total fund of the current term. Note that the total fund equals to a sum of the actual fund of each of the non-bid members or equal to the sum minus a system service fee of each of the non-bid members.

Assumed conditions are described hereafter according to FIG. 11 and FIG. 12 for describing examples in implementing the bid funding method and the bid processing system disclosed in the present invention in a detailed manner. Suppose a first member decides to attend a mutual fund association run by the bid processing system 20, then the first member uses the client terminal 30 to log in the bid processing system 20 to issue a membership application, which includes the above-mentioned personal information of the first member. The member application module 21 receives the membership application of the first member and is responsible for examining the membership application with the aid of the credit reference agency.

After examination of the membership application of the first member passes, the first member becomes a qualified member for the bid processing system 20 and mutual fund associations run by the bid processing system 20. The first member is supposed to be qualified to enter a certain mutual fund association, which has thirteen terms indicated by thirteen members of the certain mutual fund association, a basic fund equal to ten thousand dollars, and a basic bid equal to three hundred dollars, where a single term is supposed to be one month in length as well. The bid processing system 20 saves memberships and related personal information of all thirteen members, which includes the first member, into the database 25 so that required information of the certain mutual fund association is saved in the database as well.

At each term of the certain mutual fund association, members have to issue either one of the first and second bidding conditions. At an n-th term, if the first member has an urge in money, the first member may issue the first bidding condition, which indicates a qualified bid, into the bid processing system 20. Else, if the first member merely intends to earn interests in the n-th term, the first member may issue the second bidding condition, which indicates an unqualified bid, into the bid processing system 20.

At the first term of the certain mutual fund association, suppose that the first member issues a qualified bid equal to three hundred dollars under the first bidding condition, a second member issues a qualified bid equal to four hundred dollars under the first bidding condition, and no member else issues the first bidding condition. Also note that there is no bid leader in the assumption. The logic unit 231 then orders the bid processing unit 232 to determine a current bid winner since there is at least one member issuing the first bidding condition, and the bid processing unit 232 determines the second member as the bid winner accordingly. Then the settlement module 24 performs the settlement of accounts for members of the certain mutual fund association. While the certain mutual fund association uses the internal bid, the second member may receive a total fund equal to (10,000−400)×(13−1)=115,200 dollars, where each non-bid member pays an actual fund equal to 10,000−400=9,600 dollars at the first term. While the certain mutual fund association uses the external bid, the second member may receive a total fund equal to 10000×(13−1)=120,000 dollars, where each non-bid member pays an actual fund equal to 10,000 dollars at the first term. Note that a bidding result of the first term is also stored in the database 25 so that the current bid winner, the non-bid winners, and the pure non-bid members may be clearly distinguished in the succeeding terms. Therefore, the first member is allowed to issue a bid at each succeeding term until he wins the bid.

At the second term of the certain mutual fund association, the first member logs in the bid processing system 20 again. According to respective credit quota of members at the second term investigated from personal information stored in the database 25, suppose that the bid processing module 23 determines the first member, a third member, a fourth member, and a fifth member to be qualified members at the second term. The first, third, fourth, and fifth members are supposed to have no urge for money at the second term, so that each of the first, third, fourth, and fifth members issues the second biding condition indicating an unqualified bid respectively, where the first member issues an unqualified bid equal to two hundred dollars, the third member issues an unqualified bid equal to one hundred dollars, and both the fourth and fifth members issue 250 dollars respectively, as supposed. While the bid processing module 23 initiates the bidding at the second term, the logic unit 231 founds that there is no member issuing the first condition so that the logic unit 231 orders the bid processing unit 233 to determine a bid winner. The bid processing unit 233 determines the third member, who issues a lowest unqualified bid equal to one hundred dollars, to be the bid winner at the second term, where the first, third, fourth, and fifth members are pure non-bid members, and the second member is a non-bid winner. While the settlement module 24 performs the settlement of accounts, and when the mutual fund association uses the internal bid, the second member, who is a non-bid winner, has to pay the basic fund 10,000 dollars; an actual fund of the first member equals 10,000+200−300=9,900 dollars, i.e., the basic fund plus the issued bid of the first member and minus the basic bid. Similarly, an actual fund of each of the fourth and fifth members equals to 10,000+250−300=9,950 dollars; the total fund retrieved by the third member from other non-bid members equals to 9,900+10,000+9,950+9,950+9,700×8=117,400, where 9,700 indicates an actual fund paid by each of the pure non-bid members failing in issuing either one of the first and second bidding conditions and calculated as the basic fund, i.e., 10,000 dollars, minus the basic bid, i.e. 300 dollars. While the settlement module 24 performs the settlement of accounts, and when the mutual fund association uses the external bid, the second member, as a non-bid winner, has to pay the basic fund plus his winning bid, i.e., 10,000+400=10,400 dollars; an actual fund of the first member equals 10,000+200=10,200 dollars, i.e., the basic fund plus the issued bid of the first member. Similarly, an actual fund of each of the fourth and fifth members equals to 10,000+250=10,250 dollars; the total fund retrieved by the third member from other non-bid members equals to 10,200+10,400+10,250+10,250+10,000×8=121,100, where 10,000 indicates an actual fund paid by each of the rest pure non-bid members failing in issuing either one of the first and second bidding conditions and calculated as the basic fund, i.e., 10,000 dollars.

At the third term of the certain fund bidding association, suppose that the bid processing module 23 determines the first, fourth, fifth, sixth, and seventh members as qualified members in issuing respective bid according to respective credit quota. Moreover, suppose that both the first and fourth members have no urge for money so that each of them issues the second bidding condition, i.e., an unqualified bid, which is assumed to be 200 or 100 dollars respectively for the first and fourth members. After the bid processing system 20 initiates the bidding at the third term, suppose that each of the fifth, sixth, seventh members respectively issues the second bidding condition, which indicates a qualified bid equal to 500, 400, or 300 dollars respectively. The logic unit 231 orders the bid processing unit 232 to determine a current winner since there is at least one member issuing the first bidding condition, and as a result, the fifth member, who issues a highest qualified bid equal to 500 dollars, is determined to be the bid winner at the third term by the bid processing unit 232, where the rest members including the first, fourth, sixth, and seventh members are pure non-bid members at the third term. While the settlement module 24 performs the settlement of accounts, and when the mutual fund association uses the internal bid, each of the second and third members, who is a non-bid winner, has to pay the basic fund 10,000 dollars; an actual fund of each of the pure non-bid members equals to 10,000−500=9,500 dollars, i.e., the basic fund minus the issued bid of the fifth member; the total fund retrieved by the fifth member from other non-bid members equals to 10,000+10,000+9,500×10=115,000. While the settlement module 24 performs the settlement of accounts, and when the mutual fund association uses the external bid, the second member, who is a non-bid winner, has to pay the basic fund plus his winning bid, i.e., 10,000+400=10,400 dollars; the third member, who is a non-bid winner, has to pay the basic fund plus his winning bid, i.e., 10,000+300=10,300 dollars; each of the rest of pure non-bid members has to pay an actual fund equal to the basic fund 10,000 dollars; the total fund retrieved by the fifth member from other non-bid members equals to 10,400+10,300+10,000×10=120,700.

At the fourth term of the mutual fund association, suppose that the bid processing system determines the first, fourth, sixth, seventh, and eighth members are qualified to issue a bid according to respective credit quota, and suppose that all of the first, fourth, sixth, seventh, and eighth members have no urge for money so that each of them issues the second bidding condition, i.e., an unqualified bid. Suppose that the first, fourth, sixth, seventh, and eighth members issue unqualified bids equal to 100, 100, 200, 200, 200 dollars respectively. After the bidding is initiated, the logic unit 23 orders the bid processing unit 233 to determine a bid winner since there is no member issuing the first bidding condition. Since both the first and fourth members issue a lowest unqualified bid equal to 100 dollars, the bid processing unit 233 may determine a bid winner to be either one of the first and fourth members in a random manner, such as drawing lots by running a program. Suppose the first member is randomly determined as the bid winner at last, so that the second, third, and fifth members are non-bid winners, and so that the other members are pure non-bid members. While the settlement module 24 performs the settlement of accounts, and when the mutual fund association uses the internal bid, the second, third, and fifth member, who are non-bid winners, have to pay the basic fund 10,000 dollars respectively; the fourth member has to pay a fund equal to 10,000+100−300=9,800 dollars, i.e., the basic fund plus a currently-issued bid of the fourth member and minus the basic bid; the non-bid members have to respectively pay a fund equal to 10,000+200−300=9,900 dollars, i.e. the basic fund plus a currently- and respectively issued bid and minus the basic bid; the total fund retrieved by the first member from other non-bid members equals to 10,000+10,000+9,800+10,000+99,00×3+9,700×5=118,000 dollars.

While the settlement module 24 performs the settlement of accounts, and when the mutual fund association uses the external bid, the second member, who is a non-bid winner, has to pay the basic fund plus his winning bid, i.e., 10,000+400=10,400 dollars; the third member, who is a non-bid winner, has to pay the basic fund plus his winning bid, i.e., 10,000+300=10,300 dollars; the fifth member, who is a non-bid winner, has to pay the basic fund plus his winning bid, i.e., 10,000+500=10,500 dollars; the fourth member pays a fund equal to 10,000+200=10,200 dollars, i.e., the basic fund plus the currently-issued bid of the fourth member; each of the sixth, seventh, and eighth members pays a fund equal to 10,000+100=10,100 dollars, i.e., the basic fund plus a currently- and respectively issued bid; the total fund retrieved by the fifth member from other non-bid members equals to 10,400+10,300+10,100+10,500+10,200×3+10,000×5=121,900 dollars. The first member becomes a non-bid winner hereafter until the mutual fund association is over. The first member has to pay a basic fund 10,000 dollars at each following term under the internal bid, and has to pay the basic fund plus his winning bid, i.e., 10,000+300=10,300 dollars, at each following term under the external bid.

Some additional details of the present invention are disclosed herein. First, membership of members of a mutual fund association may be exchanged or transferred within the mutual fund association, i.e., rights and obligations of any two members of the mutual fund association may be transferred or exchanged to each other, however, any transfer or exchange related to anyone outside the mutual fund association is prohibited. Second, rights of each member of the mutual fund association may be effectively ensured with the aid of the credit reference agency cooperating with the bid processing system of the present invention.

Speaking of the exchange or transfer between members of the mutual fund association, the transferred or exchanged rights may include issuing a bid until winning the bid and receiving the total fund while winning a bid, and the transferred or exchanged obligations may include paying a fund at each term, i.e. an interest for the bid winner. The membership of a member may also indicate an ownership of the member, and is transferable within the mutual fund association. As a result, such transfer is easy and convenient for members of the mutual fund association since required information, inclusive of the rights and obligations of a member, has been completely stored by the database of the bid processing system.

Speaking of ensuring credits of each member of the mutual fund association, a credit of each the member has to be investigated by the credit reference agency so that each member entering the mutual fund association through the bid processing system is guaranteed to be qualified, and moreover, before each term of the mutual fund association, each the member is also confirmed by the bid processing system once to make sure whether he is qualified in issuing a bid at a current term according to a respective credit quota. In some embodiments of the present invention, while a member fails to pay his fund at preceding terms, the bid processing system may suspend his right in issuing a bid until he completely pays his fund under his obligations, so that bad debts of the member can be effectively prohibited.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A fund bidding method implemented on a bid processing system, comprising:
the bid processing system establishing a mutual fund association; and
the bid processing system initiating a bidding for unqualifiedly-issued bids while there is no member of the mutual fund association issuing a first bidding condition and while there is at least one member of the mutual fund association issuing a second bidding condition, the first bidding condition indicating a qualified bid higher than a basic bid regulated by the mutual fund association, and the second bidding condition indicating an unqualified bid lower than the basic bid.

2. The fund bidding method of claim 1 further comprising:
the bid processing system determining a bid winner to be a member who issues a lowest unqualified bid according to the second bidding condition, and the bid processing system determining a bid winner from a plurality of members who issue a same lowest unqualified bid according to the second bidding condition in a random manner.

3. The fund bidding method of claim 1 further comprising:
the bid processing system initiating a bidding for qualifiedly-issued bids while there is at least one member of the mutual fund association issuing the first bidding condition; and
the bid processing system determining a bid winner who issues a highest qualified bid according to the first bidding condition.

4. The fund bidding method of claim 1 further comprising:
the bid processing system setting a bid of a member to be a default bid while the member does not issue the first bidding condition or the second bidding condition.

5. The fund bidding method of claim 1 wherein the basic bid equals to 0.

6. The fund bidding method of claim 1 further comprising:
the bid processing system issuing a first message to have each of non-bid members of the mutual fund association pay an actual fund, which indicates a basic fund plus an unqualified bid issued by each of the non-bid members at a current term; and
the bid processing system issuing a second message to have a bid winner of a current term retrieve a total fund, which equals to a sum of an actual fund of each of non-bid members of the mutual fund association or equals to the sum minus a system service fee of each of the non-bid members.

7. The fund bidding method of claim 6,
wherein the non-bid members comprise at least one of a non-bid winner or a pure non-bid member, the non-bid winner wins a bid in a preceding term of the mutual fund association, and the pure non-bid member never wins a bid in any preceding terms;
wherein at each term of the mutual fund association, an actual fund paid by each the non-bid winner equals to a basic fund, which is regulated by the mutual fund association;
wherein when there is at least one member issuing the first bidding condition, an actual fund paid by a pure non-bid member equals to the basic fund minus a winning bid at the current term;
wherein when there is no member issuing the first bidding condition, an actual fund paid by the pure non-bid member equals to the basic fund plus an issued bid of the pure non-bid member and minus a basic bid at the current term;
wherein when the mutual fund association uses internal bids, the total fund retrieved by the bid winner equals to
Aₙ=(U−Iₙ)×(N−n)+U×(n−1);
wherein Aₙ indicates the total fund of the bid winner at an n-th term of the mutual fund association, U indicates the basic fund, N indicates a total number of terms of the mutual fund association, n indicates a current term of the mutual fund association with n being less than N, Iₙ indicates an issued bid of the bid winner at the n-th term.

8. The fund bidding method of claim 6,
wherein the non-bid members comprise non-bid winners, each of whom wins a bid in a preceding term of the mutual fund association, and pure non-bid members, each of whom never wins a bid in any preceding terms;
wherein at each term of the mutual fund association, an actual fund paid by each the non-bid winner equals to a basic fund plus an issued winning bid of each the non-bid winner, the basic fund being regulated by the mutual fund association, and the issued winning bid is issued by each the non-bid winner at a preceding term of the mutual fund association;
wherein when there is at least one member issuing the first bidding condition, an actual fund paid by a pure non-bid member equals to the basic fund;
wherein when there is no member issuing the first bidding condition, an actual fund paid by the pure non-bid member equals to the basic fund plus an issued bid of the pure non-bid member;
wherein when the mutual fund association uses external bids, the total fund retrieved by the bid winner equals to
$${A}_{n} = U \times ( N - n ) + U \times ( n - 1 ) + {\sum }_{i = j}^{n - j} {I}_{i} ;$$
wherein Aₙ indicates the total fund of the bid winner at an n-th term of the mutual fund association, U indicates the basic fund, N indicates a total number of terms of the mutual fund association, n indicates a current term of the mutual fund association with n being less than N, Iₙ indicates an issued bid of the bid winner at the n-th term, and Iᵢ indicates an issued bid of a bid winner at the i-th term with i being less than n.

9. The fund bidding method of claim 1,
wherein when there is a bid leader initiating the mutual fund association, a winning bid at the first term is directly set to 0.

10. The fund bidding method of claim 1,
wherein when there is no bid leader, the winning bid at the first term is determined according to issued first or second bidding conditions of members of the mutual fund association;
wherein the bid processing system cooperates with a credit reference agency to perform settlement of accounts of members of the mutual fund association so that the credit reference agency receives an actual fund from each of non-bid members and gives a total fund to a current bid winner at each term of the mutual fund association.

11. The fund bidding method of claim 1,
wherein membership of members of the mutual fund association may be exchanged or transferred within the mutual fund association, and any transfer or exchange related to anyone outside the mutual fund association is prohibited.

12. A fund bidding method implemented on a bid processing system, comprising:
establishing a mutual fund association by a bid processing system;
the bid processing system determining a winning bid at a first term of the mutual fund association according to issued bids of members of the mutual fund association when there is no bid leader in the mutual fund association;
the bid processing system determining a winning bid at succeeding terms of the first term according to qualifiedly-issued bids, which are higher than a basic bid regulated by the mutual fund association, of the members of the mutual fund association; and
performing exchange and transfer within the mutual fund association, wherein any transfer or exchange related to anyone outside the mutual fund association is prohibited;
wherein the bid processing system cooperates with a credit reference agency to investigate credit line of the members of the mutual fund association or perform settlement of accounts of the members of the mutual fund association so that the credit reference agency is capable of ensuring credits of members of the mutual fund association.

13. The fund bidding method of claim 12,
wherein the bid processing system determining the winning bid at the succeeding terms of the first term according to qualifiedly-issued bids comprises:
the bid processing system determining a bid winner who issues a highest qualified bid.

14. The fund bidding method of claim 12 further comprising:
the bid processing system issuing a first message to have each of non-bid members of the mutual fund association pay an actual fund, which indicates a basic fund plus an unqualified bid issued by each of the non-bid members at a current term; and
the bid processing system issuing a second message to have a bid winner of a current term retrieve a total fund, which equals to a sum of an actual fund of each of non-bid members of the mutual fund association or equals to the sum minus a system service fee of each of the non-bid members.

15. The fund bidding method of claim 14,
wherein the non-bid members comprise non-bid winners, each of whom wins a bid in a preceding term of the mutual fund association, and pure non-bid members, each of whom never wins a bid in any preceding terms;
wherein at each term of the mutual fund association, an actual fund paid by each the non-bid winner equals to a basic fund, which is regulated by the mutual fund association;
wherein when there is at least one member issuing a qualified bid, an actual fund paid by a pure non-bid member equals to the basic fund minus a winning bid at the current term.

16. The fund bidding method of claim 15 wherein the basic bid equals to 0.

17. The fund bidding method of claim 16,
wherein the non-bid members comprise non-bid winners, each of whom wins a bid in a preceding term of the mutual fund association, and pure non-bid members, each of whom never wins a bid in any preceding terms;
wherein at each term of the mutual fund association, an actual fund paid by each the non-bid winner equals to a basic fund plus an issued winning bid of each the non-bid winner, the basic fund being regulated by the mutual fund association, and the issued winning bid is issued by each the non-bid winner at a preceding term of the mutual fund association;
wherein when there is at least one member issuing a qualified bid, an actual fund paid by a pure non-bid member equals to the basic fund.

18. A fund bidding method implemented on a bid processing system, comprising:
the bid processing system establishing a mutual fund association;
the bid processing system initiating a bidding for unqualifiedly-issued bids while there is no member of the mutual fund association issuing a first bidding condition and while there is at least one member of the mutual fund association issuing a second bidding condition, the first bidding condition indicating a qualified bid higher than a basic bid regulated by the mutual fund association, and the second bidding condition indicating an unqualified bid lower than the basic bid;
the bid processing system determining a winning bid at a first term of the mutual fund association according to issued bids of members of the mutual fund association when there is no bid leader in the mutual fund association; and
performing exchange and transfer within the mutual fund association, wherein any transfer or exchange related to anyone outside the mutual fund association is prohibited;
wherein the bid processing system cooperates with a credit reference agency to investigate credit line of the members of the mutual fund association or perform settlement of accounts of the members of the mutual fund association so that the credit reference agency is capable of ensuring credits of members of the mutual fund association.

19. The fund bidding method of claim 18 further comprising:
the bid processing system determining a bid winner to be a member who issues a lowest unqualified bid according to the second bidding condition;
the bid processing system determining a bid winner from a plurality of members who issue a same lowest unqualified bid according to the second bidding condition in a random manner; and
the bid processing system setting a bid of a member to be a default bid while the member does not issue the first bidding condition or the second bidding condition.

20. The fund bidding method of claim 18 further comprising:
the bid processing system initiating a bidding for qualifiedly-issued bids while there is at least one member of the mutual fund association issuing the first bidding condition; and
the bid processing system determining a bid winner who issues a highest qualified bid according to the first bidding condition.

21. The fund bidding method of claim 18 further comprising:
the bid processing system issuing a first message to have each of non-bid members of the mutual fund association pay an actual fund, which indicates a basic fund plus an unqualified bid issued by each of the non-bid members at a current term; and
the bid processing system issuing a second message to have a bid winner of a current term retrieve a total fund, which equals to a sum of an actual fund of each of non-bid members of the mutual fund association or equals to the sum minus a system service fee of each of the non-bid members.

22. The fund bidding method of claim 21,
wherein the non-bid members comprise non-bid winners, each of whom wins a bid in a preceding term of the mutual fund association, and pure non-bid members, each of whom never wins a bid in any preceding terms;
wherein at each term of the mutual fund association, an actual fund paid by each the non-bid winner equals to a basic fund, which is regulated by the mutual fund association;
wherein when there is at least one member issuing the first bidding condition, an actual fund paid by a pure non-bid member equals to the basic fund minus a winning bid at the current term;
wherein when there is no member issuing the first bidding condition, an actual fund paid by the pure non-bid member equals to the basic fund plus an issued bid of the pure non-bid member and minus a basic bid at the current term;
wherein when the mutual fund association uses internal bids, the total fund retrieved by the bid winner equals to
Aₙ=(U−Iₙ)×(N−n)+U×(n−1);
wherein Aₙ indicates the total fund of the bid winner at an n-th term of the mutual fund association, U indicates the basic fund, N indicates a total number of terms of the mutual fund association, n indicates a current term of the mutual fund association with n being less than N, and Iₙ indicates an issued bid of the bid winner at the n-th term.

23. The fund bidding method of claim 21,
wherein the non-bid members comprise non-bid winners, each of whom wins a bid in a preceding term of the mutual fund association, and pure non-bid members, each of whom never wins a bid in any preceding terms;
wherein at each term of the mutual fund association, an actual fund paid by each the non-bid winner equals to a basic fund plus an issued winning bid of each the non-bid winner, the basic fund being regulated by the mutual fund association, and the issued winning bid is issued by each the non-bid winner at a preceding term of the mutual fund association;
wherein when there is at least one member issuing the first bidding condition, an actual fund paid by a pure non-bid member equals to the basic fund;
wherein when there is no member issuing the first bidding condition, an actual fund paid by the pure non-bid member equals to the basic fund plus an issued bid of the pure non-bid member;
wherein when the mutual fund association uses internal bids, the total fund retrieved by the bid winner equals to
$${A}_{n} = U \times ( N - n ) + U \times ( n - 1 ) + {\sum }_{i = j}^{n - j} {I}_{i} ;$$
wherein Aₙ indicates the total fund of the bid winner at an n-th term of the mutual fund association, U indicates the basic fund, N indicates a total number of terms of the mutual fund association, n indicates a current term of the mutual fund association with n being less than N, Iₙ indicates an issued bid of the bid winner at the n-th term, and Iᵢ indicates an issued bid of a bid winner at the i-th term with i being less than n.
